(19) United States
(12) Patent Application Publication
(10) Pub. No.: US 2009/0094285 A1
(43) Pub. Date: Apr. 9, 2009

(54) RECOMMENDATION APPARATUS

(76) Inventors: Edward G. Mackle, Dublin (IE); Eamon Phelan, Kilkenny (IE); Keith Pilson, Dublin (IE); Aaron Quigley, Dublin (IE); Declan Tarrant, Killorglin (IE)

Correspondence Address: HOFFMAN WARNICK LLC, 75 STATE ST, 14TH FLOOR, ALBANY, NY, 12207, US

(21) Appl. No.: 12/243,136

(22) Filed: Oct. 1, 2008

(30) Foreign Application Priority Data
Oct. 3, 2007 (EP) 07117807.3

(51) Int. Cl. G06F 17/30

(52) U.S. Cl. 707/104.1; 707/E17.101

(57) ABSTRACT

A recommendation apparatus for selecting, by comparing one or more media files from a plurality of received recommendations, one or more media files for inclusion into a digital media file. A recommendation apparatus in accordance with an embodiment includes: a main controller component for receiving a plurality of recommendations associated with one or more media files from a plurality of recommenders; a weighting component for determining a weighting factor associated with each of the received recommendations; a weighting component for identifying from each of the determined weighting factors each of the recommendations falling within a predetermined threshold and for selecting each of these recommendations for inclusion into an audio playlist.

### FIELD OF THE INVENTION

The invention relates to the field of data processing systems. In particular, the invention relates to a recommendation apparatus for determining media to be incorporated into a digital media file.

### BACKGROUND OF THE INVENTION

A podcast is a digital media file that is distributed over a network such as the Internet. A podcast can comprise a selection of media, for example, music tracks, extracts of a news broadcast and a recording of a radio show. Any type of audio media can be selected for inclusion into a podcast, for example, any type of audio or visual file such as a music file or a video file, etc. A podcast usually has a number of episodes associated with it. For example, podcasts may be available for a particular radio show. These podcasts are recorded on a daily basis and each one of these daily recorded podcasts is commonly called an episode.

Typically, a content provider makes available media files on the Internet. The content provider advertises the existence of the media file by referencing the file in a data feed. The data feed is typically a list of URLs by which one or more episodes of a podcast may be accessed. Users wishing to access podcasts use a special application called a podcast receiver or catcher application which is typically part of a media playing application. The application runs in the background on the user's computer and periodically checks for updates in the data feed. If the data feed has changed since it was last checked the application downloads the podcast for adding to the user's audio playlist for playing on the user's computer or on another media playing device.

Podcasting is a very useful mechanism for collating numerous media sources into one media file for accessing by a number of users. However, when used as a mechanism in which to purvey information to a number of individuals in an organization, it is often difficult to decide which media files should be included as part of a podcast and which files should not be incorporated. For example, if podcasting is used as a way in which to educate a chosen audience on an aspect of quantum physics, it is often difficult to know where to begin with the wide range of media files available on the subject. Thus, the person tasked with generating the podcast has a very difficult job on their hands. Taking this a step further—if the person tasked with generating the podcast asked a number of an intended audience which media files should be incorporated into a podcast the majority of the audience would have conflicting views and opinions. Some of the audience would have more knowledge and experience of quantum physics would be better placed to suggest which media files should be included and which should not be.

### SUMMARY OF THE INVENTION

Viewed from a first aspect, the present invention provides a recommendation apparatus for selecting, by comparing one or more media files from a plurality of received recommendations, one or more media files for inclusion into a digital media file, the recommendation apparatus comprising: a main controller component for receiving a plurality of recommendations associated with one or more media files from a plurality of recommenders; a weighting component for determining a weighting factor associated with each of the received recommendations; a weighting component for identifying from each of the determined weighting factors each of the recommendations falling within a predetermined threshold and for selecting each of these recommendations for inclusion into an audio playlist.

The present invention provides a recommendation apparatus wherein a weighting factor is representative of a conferred average rating associated with each of the plurality of recommenders and the highest number of recommendations received by any recommender. The weighting factor may further comprise the weighting component mapping a set of rules against an organizational tree structure in order to determine a recommender's rank in an organization. The present invention provides a recommendation apparatus that further comprises an audio generator component for identifying a selected media file as a text file, a text to speech converter for converting the identified text file into an audio file, a publication component for providing a list of all recommendations which have been selected for inclusion into a podcast and means for receiving a vote from a recommender based on a criterion for at least one of the selected recommendations, and a subscription component for receiving a subscription to digital media file from a subscriber. The present invention further provides a recommendation apparatus wherein the digital media file is a podcast.

Viewed from a second aspect the present invention provides a method for selecting, by comparing one or more media files from a plurality of received recommendations, one or more media files for inclusion into a digital media file, the method comprising: receiving a plurality of recommendations associated with one or more media files from a plurality of recommenders; determining a weighting factor associated with each of the received recommendations; identifying from each of the determined weighting factors each of the recommendations falling within a predetermined threshold; and selecting each of these recommendations for inclusion into an audio playlist.

The present invention provides a method wherein a weighting factor is representative of a conferred average rating associated with each of the plurality of recommenders and the highest number of recommendations received by any recommender. The weighting factor is further derived from a step of mapping a set of rules against an organizational tree structure in order to determine a recommender's rank in an organization.

The present invention provides a method further comprising the steps of: identifying a selected media file as a text file; converting the identified text file into an audio file; providing a list of all recommendations which have been selected for inclusion into a podcast, receiving a vote from a recommender based on a criterion for at least one of the selected recommendations, and receiving a subscription to digital media file from a subscriber. The digital media file may comprise a podcast.

Viewed from a third aspect the present invention provides a computer program product loadable into the internal memory of a digital computer, comprising software code portions for performing, when the product is run on a computer, the invention as described above.

### BRIEF DESCRIPTION OF THE DRAWINGS

Embodiments of the invention are described below in detail, by way of example only, with reference to the accompanying drawings.

FIG. 1 is an example of a client and server architecture in which an embodiment of the present invention may be embodied.

FIG. 2 is an example of a data processing system in which an embodiment of the present invention may be embodied.

FIG. 3 is a block diagram detailing a client device having a recommendation client in accordance with an embodiment of the present invention.

FIG. 4 is a block diagram showing a recommendation server in accordance with an embodiment of the present invention.

FIGS. 5a and 5b are flow charts detailing the interactions between the recommendation client and the recommendation server in accordance with an embodiment of the present invention.

FIG. 6 is a flow chart detailing the process steps of the recommendation server in accordance with an embodiment of the present invention.

### DETAILED DESCRIPTION OF THE INVENTION

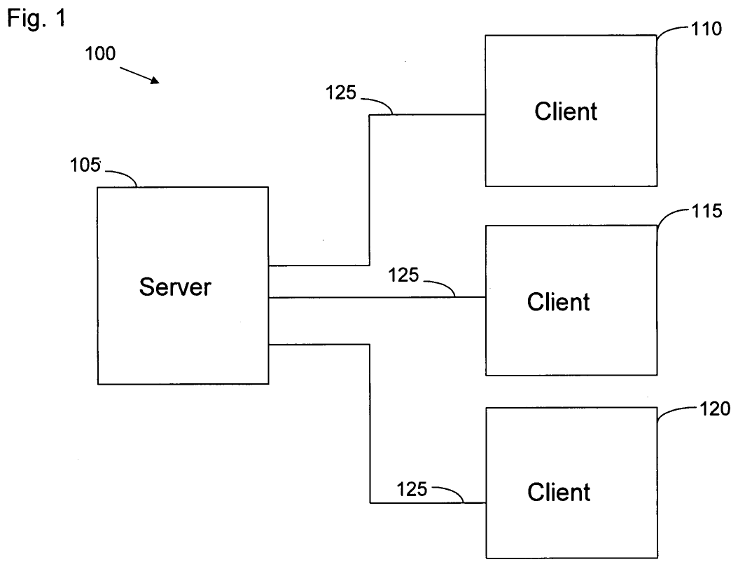

FIG. 1 shows a typical example of a client and server architecture 100 in which an embodiment of the present invention may be operable. A number of client devices 110, 115, 120 are connectable via a network 125 to a server 105. The server 105 stores data which is accessible (with the appropriate access permissions) by one or more of the client devices 110, 115, 120. The network 125 can be any type of network 125 including but not limited to a local area network, a wide area network or a wireless network, etc. The server can be a web server or other type of application server. Likewise, a client device 110, 115, 120 may be a web client or any type of client device 110, 125, 120 which is operable for sending requests for data to and receiving data from the server 105.

In one example, client devices 110, 115, 120 may comprise a podcast receiver or catcher application for interacting with data feeds stored on a server 105. The data feeds may be any type of data feed which notifies subscribers of newly available podcasts. For example, the server 105 may host a website displaying information associated with a radio station, the radio station's timetable for a particular day, other pieces of news items, and podcasts of radio shows available for downloading via a data feed.

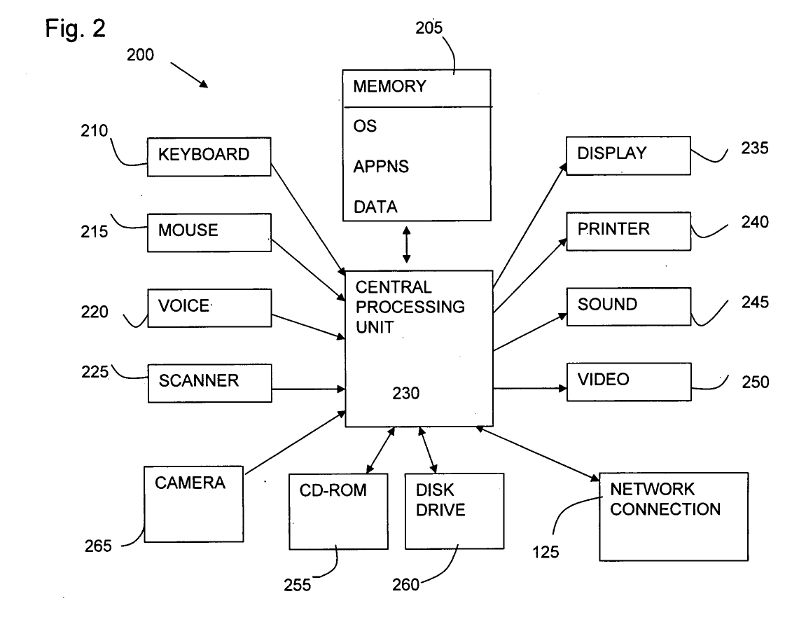

Referring to FIG. 2 an example of computer system 200 is shown of the type that would be operable on a client device and a server.

The data processing system 200 comprises a central processing unit 230 with primary storage in the form of memory 205 (RAM and ROM). The memory 205 stores program information and data acted on or created by application programs. The program information includes the operating system code for the data processing system 200 and application code for applications running on the computer system 200. Secondary storage includes optical disk storage 255 and magnetic disk storage 260. Data and program information can also be stored and accessed from the secondary storage.

The data processing system 200 includes a network connection means 205 for interfacing the data processing system 200 to a network 125. The data processing system 200 may also have other external source communication means such as a fax modem or telephone connection.

The central processing unit 230 comprises inputs in the form of, as examples, a keyboard 210, a mouse 215, voice input 220, a camera 265 and a scanner 225 for inputting text, images, graphics or the like. Outputs from the central processing unit 230 may include a display means 235, a printer 240, sound output 245, video output 250, etc.

Applications may run on the data processing system 200 from a storage means 260 or via a network connection 125, which may include database applications etc.

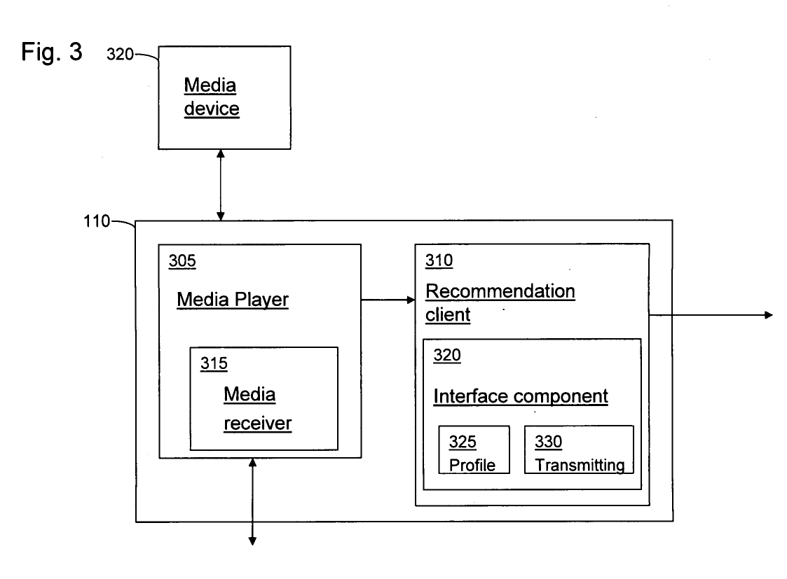

Moving on to FIG. 3, an embodiment of the present invention is shown. Client devices 110, 115, 120 comprise a media player component 305 which is operable for incorporating a podcast receiver application 315. An example of this type of application 315 is iTunes which is a trademark of Apple Inc., in the US and other countries. iTunes allows for users to receive notifications of availability of episodes of podcasts, download these episodes, and play them via the iTunes media playing application. Other functionality provided is the ability to be able to manage, categorize and create playlists, etc.

The media player application 305 is operable for connection to a media playing device 300 such as, for example, an iPod (iPod is a trademark of Apple Inc. in the US and other countries) or other types of media playing devices.

The media receiver component 315 receives notifications of the availability of newly generated episodes of a podcast for downloading. The media receiver component 315 is then able to download the available podcast on to the client devices 110, 115, 120 for playing or for transferring to a media device 300 for storing and playing.

Client devices 110, 115, 120 further comprise a recommendation component 310 which is operable for communication with the media player application 305. The recommendation component 310 can either be implemented as a stand-alone application operable on client devices 110, 115, 120 or can be integrated as part of the media playing application 305.

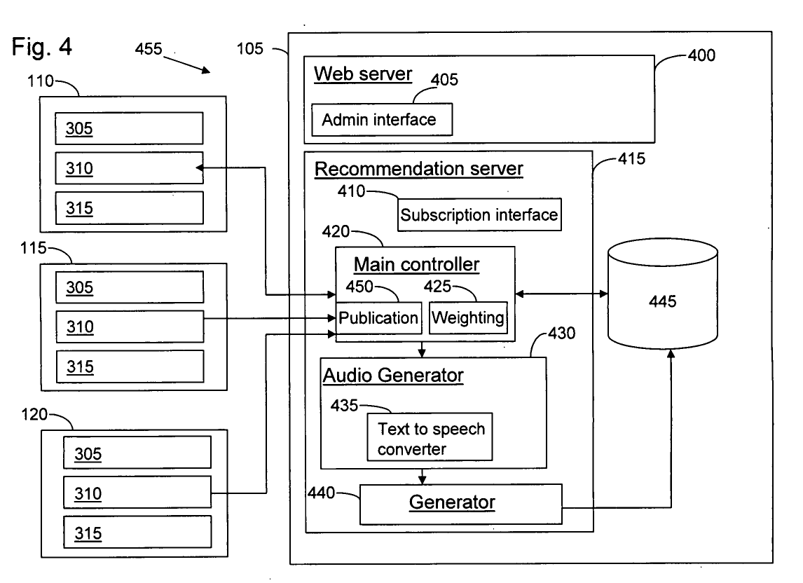

The recommendation component 310 allows a user to select, via an interface component 320, one or more media files that they wish to recommend to the recommendation server 415 (FIG. 4) for inclusion into an episode of a podcast. For example, a user may wish to recommend a music track, a text file or a video frame.

The interface component 320 allows a user to select any type of media file that the user wishes to be recommended for inclusion into the podcast. This is because the recommendation server 415 is able to convert a text file into an audio file for inclusion into the podcast. Please see the explanation to FIG. 4 for more information. Thus the user can select a text file created by a word-processing application or a PDF file for inclusion into the podcasts as well as audio files.

The interface component 320 allows for the selection of the physical file, i.e., a PDF document located on a physical storage means of a data processing system or from the physical storage means of a networked storage device or a URL associated with an address of a request resource.

The interface component 320 also comprises a transmitting component 330 for transmitting the selected media or the URL address to the recommendation server 415 for processing and a unique identifier associated with the user. For clarity, the terms media should be understood to comprise music files, video files, audio files, text documents, and all means for gaining access to the media files including URL addresses.

The interface component 320 also provides a list of all media that has been recommended to the recommendation server 415 in the past so that a user can provide a rating which is indicative of the value or usefulness of the media to the user.

A profile component 325 stores information associated with the interests of a user. For example, a list of episodes of podcasts that a user has subscribed to, a list of episodes of podcasts that a user can subscribe to, and other user associated preferences such as the frequency in which user's would like to be notified of newly available episodes of podcast.

Moving onto to FIG. 4 the recommendation server 415 is shown. The recommendation server 415 receives and processes recommendations from client devices 110, 115, 120. The recommendation server 415 is operable for operating in a network as a unitary server or the recommendation server 415 is operable for interfacing with a web server 400 or application server as shown in the arrangement of FIG. 4. A skilled person in the art will also realize that other arrangements are also possible without departing from the scope of the invention.

The recommendation server 415 comprises a number of components which interact and interface with each other in order to provide the benefits of an embodiment of the present invention. The recommendation server 415 comprises a main controller component 420 which is operable for receiving recommendations from one or a plurality of client devices 110, 115, 120. The main controller component 420 also comprises a weighting component 425 for determining a weighting that should be assigned to each of the received recommendations.

The recommendation server 415 further comprises a publication component 450 for publishing a list of selected recommendations to each of the subscribing client devices 110 and for receiving votes from any of the subscribing client devices 110, 115, 120 associated with any of the published recommendations, and an audio playlist generator component 430 having a text to speech converter 435. The text to speech converter 435 converts the text located within any text document into speech for generating an audio file for inclusion into the podcast. A podcast generator component 440 receives each of the recommendations from the weighting component 425 and packages each of the weighted recommendations into a podcast for either transmitting to each subscribed user or for communication of a notification of the availability of the generated podcast to each of the subscribed users.

Interfacing with the recommendation server 415 is a web server 400 which comprises an administration interface 405. The administration interface 405 receives configuration data from an administrator of the recommendation server 415. For example, the configuration settings may comprise an instruction to alter the weightings of a weighting algorithm and/or grant access rights to users requesting access to podcasts generated by the recommendation server.

Moving back to the recommendation server 415, the main controller 420 receives recommendations for particular types of media to be incorporated into a podcast episode from a plurality of client devices 110, 115, 120. A received recommendation comprises a data packet comprising the recommended media, a unique ID associated with a user making the recommendation, and any information providing a description of the media.

The main controller 420 extracts from the data packet the recommended media, the unique ID, and any description. If the recommended media comprises the physical media, i.e., a word-processing file or a music file, etc, the main controller 420 stores the media in a data store 450. If the recommended media comprises a URL address, the main controller 420 obtains a copy of the media located at the URL address and stores the data in the data store 450.

The main controller 420 also logs each received recommendation in a recommendation table, as shown in Table 1.

TABLE 1
Recommendation Table

| Date | Recommender | Media | Description | Type |
|---|---|---|---|---|
| 15-05-07 | IEU68561 | http://localhost/abcd.mp3 | Abcd music file | 4 |
| 15-05-07 | IEU45627 | http://localhost/cded.pdf | Intro to environmental | 3 |
| | | | changes | |
| 15-05-07 | IEU67890 | http://localhost/zxyd.txt | Environmental | 2 |
| | | | changes | |
| 15-05-07 | IEU34533 | http://localhost/mnod.doc | Guide to travel | 1 |
| 22-05-07 | IEU63046 | http://localhost/dfgfd.mp3 | Latest group | 4 |
| 22-05-07 | IEU45627 | http://localhost/fdgf.pdf | Intro to quantum | 3 |
| | | | physics | |
| 22-05-07 | IEU68561 | http://localhost/fgdg.mp3 | Music file | 4 |
| 22-05-07 | IEU45627 | http://localhost/tyrt.pdf | PDF file | 3 |
| 22-05-07 | IEU67890 | http://localhost/jklj.txt | Text file | 2 |
| 22-05-07 | IEU34533 | http://localhost/awed.doc | | 1 |
| 29-05-07 | IEU37680 | http://localhost/qwer.mp3 | Music Indie | 4 |
| 29-05-07 | IEU68561 | http://localhost/tyu.mp3 | Music R&B | 4 |
| 29-05-07 | IEU45627 | http://localhost/iop.pdf | Weather patterns | 3 |
| 29-05-07 | IEU67890 | http://localhost/asd.txt | Quantum physics | 2 |
| 29-05-07 | IEU34533 | http://localhost/fgh.doc | | 1 |
| 05-06-07 | IEU68561 | http://localhost/jkl.mp3 | | 4 |
| 05-06-07 | IEU45627 | http://localhost/zxc.pdf | | 3 |
| 05-06-07 | IEU67890 | http://localhost/vbn.txt | | 2 |
| 05-06-07 | IEU34533 | http://localhost/mqw.doc | | 1 |

Firstly, the main controller 420 logs the user's unique identifier, the URL of the media and any description of the media supplied by the recommending user. Next, the main controller 420 prefixes the date of next scheduled podcast into the appropriate row in the table. In an alternative embodiment the date of the next scheduled podcast can be obtained by performing a lookup in a table in response to a user recommending media for a particular type of podcast. For example, a user may wish to recommend media for inclusion into a podcast on the subject area of negotiation techniques. In this example, the main controller 420 would perform a lookup and locate the date of the next scheduled podcast episode for negotiation techniques. The located date is then written to the table next to a recommendation entry for a negotiation techniques podcast. In Table 1 it can be seen that the next scheduled podcast is 05-06-2007.

The type value, as shown in Table 1, is located by performing a look-up in a type table, as shown in Table 2. In order to locate the type value, the main controller 420 analyzes the URL address or the properties of a media file to determine its properties type. For example, the URL http://localhost/abcd.mp3 is an mp3 audio file. Thus the main controller 420 performs a look up in the type table (Table 2) and locates an entry for the file type mp3, which is shown in Table 2 to have an assigned value of 4. The value 4 is then written to the recommendation table (Table 1) next to the appropriate entry.

TABLE 2
Type Table

| Type | File Type |
|---|---|
| 1 | Txt |
| 2 | Doc |
| 3 | PDF |
| 4 | mp3 |
| 5 | Html |

The Recommendation table (Table 1) stores all recommendations made to the recommendation server 415 over a predetermined time period.

The recommendation server 415 also comprises a ratings table which stores an entry for each item of content that has been rated on a previous occasion. An example of a Ratings table is shown in Table 3.

TABLE 3
Ratings Table

| Media | Rating | Number |
|---|---|---|
| http://localhost/abcd.mp3 | 3.3 | 12 |
| http://localhost/cded.pdf | 4.4 | 3 |
| http://localhost/zxyd.txt | 2.8 | 14 |
| http://localhost/mnod.doc | 4.6 | 9 |
| http://localhost/dfgfd.mp3 | 2.1 | 21 |
| http://localhost/fdgf.pdf | 3.7 | 16 |
| http://localhost/fgdg.mp3 | 1.8 | 7 |
| http://localhost/tyrt.pdf | 3.5 | 19 |
| http://localhost/jklj.txt | 4.1 | 29 |
| http://localhost/awed.doc | 4.7 | 13 |
| http://localhost/qwer.mp3 | 2.3 | 17 |
| http://localhost/tyu.mp3 | 3.5 | 31 |
| http://localhost/iop.pdf | 1.2 | 44 |
| http://localhost/asd.txt | 2.6 | 21 |
| http://localhost/fgh.doc | 1.4 | 12 |

A user can assign a rating value to media via the recommendation client 310. The rating value assigned can be a value selected from a range of values, for example a range can be integer values from 0 to 5. As shown in Table 3, the ratings table comprises an entry for the location of the media, an average rating value, and the number of users who have rated the identified media. A user can only rate an item of media once the media has been logged in the recommendations table (Table 1). The list of recommendations from the recommendations table (Table 1) is displayed to a user via the recommendation client 310 (as previously explained with reference to FIG. 3).

As users rate media the user's assigned rating value is used to calculate a new average rating for the media. For example, if a user enters the integer value 4 as their rating for a media entry, and using an example of the second entry in Table 3, the calculation would be as follows:

Average rating=(entered using rating+(current rating)*number of ratings)/(number of ratings+1).

Therefore using the above formulae, the rating would be calculated as follows:

Average rating=(4.0+(4.4)3)/4=4.3.

Thus the average value is 4.3 which will overwrite the existing average value of 4.4. The number of entries received is incremented by 1 and thus the new entry would be as follows:
Referring back to Table 1, it is shown that on the 05-06-2007, the recommendation server 415 must generate a podcast. In order to generate the podcast the weightings component 425 calculates three factors which are to be taken into consideration in order to select the top N entries for inclusion into the podcast. These factors are as follows:
The average conferred rating for each of the recommenders previous

| | | |
|---|---|---|
| http://localhost/cded.pdf | 4.3 | 4 |

recommendations (F1)
The assigned rank with in, for example an organization, of the recommender (F2)
The number of recommendations the recommender has made in the past (F3)

Each factor should have a value between 0 and 1 so that 0<=X<=1. However, a person skilled in the art would realize that other forms of values can be used without departing from the scope of the invention.

### Calculation of the Factors

### Calculating F₁

With reference to Table 1, the main controller 415 parses the table and identifies that a podcast is to be generated on the 05-06-2007. The first entry in the table for the 05-06-2007 podcast is one recommended by IEU68561.

Extract from Table 1

| | | | | |
|---|---|---|---|---|
| 05-06-07 | IEU68561 | http://localhost/jkl.mp3 | JKL music file | 4 |

The main controller 420 then proceeds to parse the remainder of Table 1 in order to identify further recommendations made by this user in the past. In this example the main controller 420 locates the records shown in the table extract below and then transmits the located records to the weightings component 425 for calculation of F1.

Extract from Table 1 - Located Records

| | | | | |
|---|---|---|---|---|
| 15-05-07 | IEU68561 | http://localhost/abcd.mp3 | Blah blah | 4 |
| 22-05-07 | IEU68561 | http://localhost/fgdg.mp3 | Blah blah | 4 |
| 29-05-07 | IEU68561 | http://localhost/tyu.mp3 | Blah blah | 4 |

The weighting component 425 parses the ratings table (Table 3) to identify the average rating for each of these recommended media entries, for example as shown Extract of Table 3 below.

Extract of Table 3 - Average Rating for each of the
Recommendation Located

| | |
|---|---|
| http://localhost/abcd.mp3 | 3.3 |
| http://localhost/fgdg.mp3 | 1.8 |
| http://localhost/tyu.mp3 | 3.5 |

The average of these ratings is therefore (3.3+1.8+3.5)/3→3.866
Since all factors must have a value between 0 and 1, the value above must be divided by 5 (since the ratings have a maximum of 5). In this case that would be

F₁→3.866/5→0.773

Thus factor F1 is calculated to be 0.773.

### Calculating F₂

The weighting component 425 calculates the rank of the recommender by performing a lookup in a directory to determine the recommender's rank with respect to an assigned community. The community may be an organization that the recommender works in, or an on-line community that the recommender has joined, etc.

An organization specific mapping will be necessary so that a value 0<=X<=1 can be generated for each recommender. For instance, if there are 10 levels in an organizational tree structure, the top position may be evaluated to 1 and the fourth level form the top to 4. Thus, using this same example, if a recommender is identified as being at level 4 then their value will be 4/10i.e. 0.4. Thus, in this example, the factor F2 is calculated as 0.4

### Calculating F₃

The weightings component 425 calculates F₃ by taking the highest number of recommendations made by any recommender to the system and equaling this to 1. So for example, if the highest number of suggestions ever made to the recommendation server by a recommender is 60 and the current recommender has only made 3 recommendations then the F2 would be calculated as 60/3=0.05

Each of these factors is assigned a different level of importance. For example, the factor F₃ is intended more for situations where two people have made different recommendations, both of which are very close to being selected for the podcast. In this case it would be best to include the recommendation made by the recommender who uses the recommendation system the most since he/she is a more loyal advocate of the recommendation system.

Next the weightings component 425 applies different weightings to each of the factors. Thus the weightings applied to F₁, F₂ and F₃ are W₁, W₂ and W₃, respectively.

An example weighting for the above might be W₁=0.45, W₂=0.45, W₃=0.1—this is divided in such a way that W1+W₂+W₃=1.

To calculate the score for the recommendation, the following formula is used;

W₁F₁+W₂F₂+W₃F₃

For this example, that would be

0.45(0.773)+0.45(0.4)+0.1(0.05)→0.533

Thus the overall score for this recommendation based on factors F1, F2 and F3 is 0.533.

The main controller 420 in combination with the weightings component 425 continues through all the recommendations made for the podcast (determined from Table 1) and calculates a score in the same way as described above for each of the recommendations. Once this is completed, the top N scores are used and the corresponding media is included in the podcast.

After this podcast is generated, corresponding entries in the rating table for each recommendation made for the podcast are created so that users can then rate this content.

Once the final recommendations have been calculated, the recommendations are transmitted by the weightings component 425 to the audio playlist generator 435 for inclusion into the appropriate podcast.

The audio generator 430 receives from the weighting component 425 the media files which have been identified as the most popular recommendations chosen by the user community. The audio generator 430 determines whether any of the media files are text documents i.e. word processing documents, or PDF documents.

If any of the recommended media files are determined to be text files the audio generator component 430 transmits a request to a text to speech converter component 435 requesting that the text in each of the files to be converted into speech. This text to speech conversion process is carried out by known techniques and thus a detailed discussion is not considered necessary. Once the text files have been converted into audio files each of the recommended media files are packages into a podcast for storing in the data store 455. An XML data feed is then generated for notifying subscribers of the availability of a podcast or an episode of a podcast.

Although an embodiment has been described with reference to generating a podcast it should be understood that the term podcast is intended to cover any form of digital media file or series of digital media files that is distributed over the internet using syndication feeds.

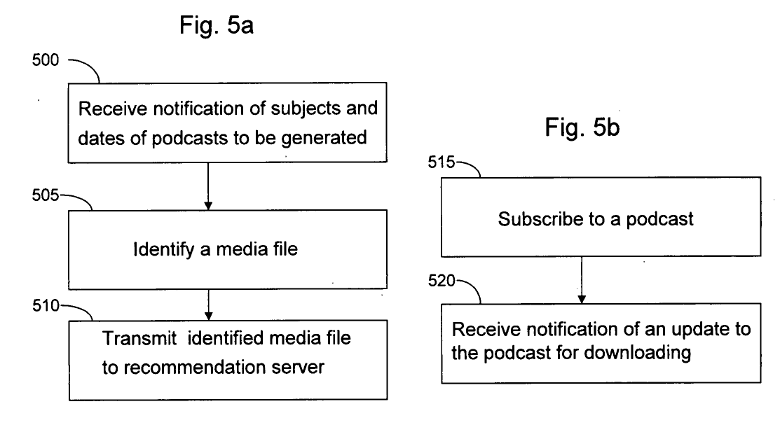

With reference to FIGS. 5a and 5b, the process steps of the recommendation client 310 are shown.

FIG. 5a explains how users can interact with the recommendation server 455. Firstly, via the recommendation client 310 user's can view a list of a podcasts that have been previously generated and episodes of those podcasts that will be available for download on a particular date (step 500). For example, on the 05-06-2007 an ‘how to get the best out of your avatar in a virtual world’ will be available for download. In a first instance, a user may just want to be notified when this is available for downloading and with reference to FIG. 5b will subscribe via the interface component to the podcast (step 515) and will wait for a notification to be received of the podcasts availability (step 520).

However, in another instance a user may want to recommend a media file for inclusion into the ‘how to get the best out of your avatar in a virtual world’ podcast. Thus moving back to FIG. 5a the user identifies a media file that they wish to recommend for including into the podcast, for example, ‘A guide to dressing your avatar for business.doc’ (step 505), adds a description about the media (although this is optional) and transmits their recommendation to the recommendation server for processing (step 510).

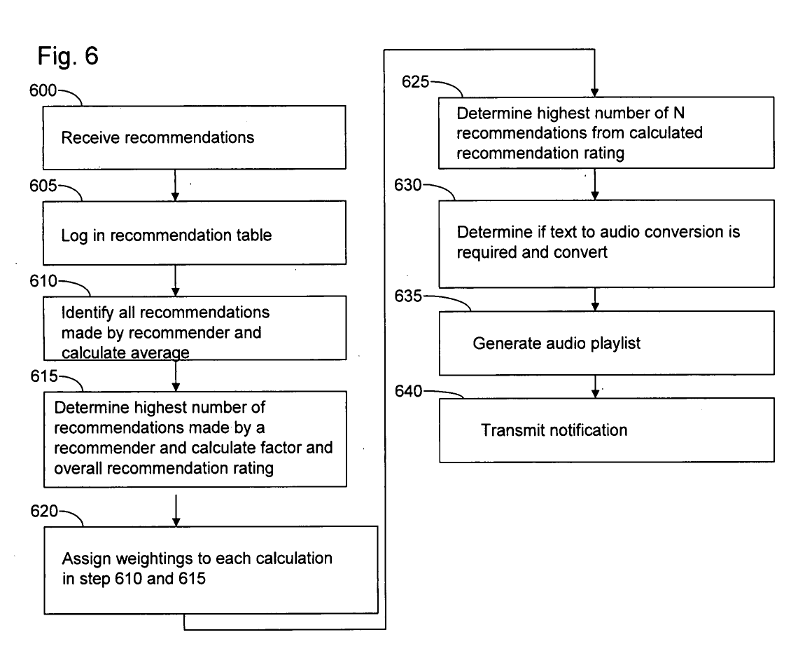

With reference to FIG. 6, the main controller 420 of the recommendation server 415 receives the recommendation from the user (step 600). Next main controller 420 identifies the user's unique identifier and the recommended media from the recommendation package and logs the recommendation in a recommendation table (step 605). Next, the main controller, using the unique identifier identified in the recommendation package parses the recommendation table to identify all recommendation previously made by the user associated with the unique identifier. Then, the main controller performs a lookup in the ratings table to identify what the average rating was for each of previously recommended media made by the user and the weightings component 425 calculates a new average conferred rating (step 610).

The weightings component 425 determines from the recommendation table the highest number of recommendations made by any recommender to the recommendation system (step 615). For example, if the highest number of recommendations made by a recommender was determined to be sixty and the current recommender has only made three recommendations, the current recommender would be assigned a value of 0.05.

The weightings component then assigns a weighting to each of the calculated factors (step 620) and from this calculates an overall recommendation rating. Based on a predetermined threshold, the weighting component 425 selects the recommendations having the N highest recommendation rating for inclusion into the podcast (step 625).

The weighting component 425 transmits the selected media and transmits the media the audio playlist generator and the audio playlist generator determines whether any of the selected media requires text to audio conversion (step 630).

The podcast is generated by the podcast generator component 445 and stored in the data store 450 (step 635). The podcast generator component also generates a notification for communication to all subscribers notifying of the availability of the podcast (step 640).

It will be clear to one of ordinary skill in the art that all or part of the method of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In one alternative, the present invention may be realized in the form of a computer implemented method of deploying a service comprising steps of deploying computer program code operable to, when deployed into a computer infrastructure and executed thereon, causes the computer system to perform all the steps of the method.

In a further alternative, the present invention may be realized in the form of data carrier having functional data thereon, the functional data comprising functional computer data structures to, when loaded into a computer system and operated upon thereby, enable the computer system to perform all the steps of the method.

It will be clear to one skilled in the art that many improvements and modifications can be made to the foregoing exemplary embodiment without departing from the scope of the present invention.

1. A recommendation apparatus for selecting, by comparing one or more media files from a plurality of received recommendations, one or more media files for inclusion into a digital media file, the recommendation apparatus comprising:
a main controller component for receiving a plurality of recommendations associated with one or more media files from a plurality of recommenders;
a weighting component for determining a weighting factor associated with each of the received recommendations; and
a weighting component for identifying from each of the determined weighting factors each of the recommendations falling within a predetermined threshold, and for selecting each of these recommendations for inclusion into an audio playlist.

2. The recommendation apparatus as claimed in claim 1, wherein a weighting factor is representative of a conferred average rating associated with each of the plurality of recommenders and a highest number of recommendations received by any recommender.

3. The recommendation apparatus as claimed in claim 2, wherein a weighting factor is derived by mapping a set of rules against an organizational tree structure in order to determine a recommender's rank in an organization.

4. The recommendation apparatus as claimed in claim 1, further comprising an audio generator component for identifying a selected media file as a text file.

5. The recommendation apparatus as claimed in claim 4, further comprising a text to speech converter for converting the identified text file into an audio file.

6. The recommendation apparatus as claimed in claim 1, further comprising a publication component for providing a list of all recommendations which have been selected for inclusion into a podcast and means for receiving a vote from a recommender based on a criterion for at least one of the selected recommendations.

7. The recommendation apparatus as claimed in claim 1, further comprising a subscription component for receiving a subscription to digital media file from a subscriber.

8. The recommendation apparatus as claimed in claim 1, wherein the digital media file is a podcast.

9. A method for selecting, by comparing one or more media files from a plurality of received recommendations, one or more media files for inclusion into a digital media file, the method comprising:
receiving a plurality of recommendations associated with one or more media files from a plurality of recommenders;
determining a weighting factor associated with each of the received recommendations; and
identifying from each of the determined weighting factors each of the recommendations falling within a predetermined threshold and selecting each of these recommendations for inclusion into an audio playlist.

10. The method as claimed in claim 9, wherein a weighting factor is representative of a conferred average rating associated with each of the plurality of recommenders and a highest number of recommendations received by any recommender.

11. The method as claimed in claim 10, wherein a weighting factor is further derived from mapping a set of rules against an organizational tree structure in order to determine a recommender's rank in an organization.

12. The method as claimed in claim 9, further comprising identifying a selected media file as a text file.

13. A method as claimed in claim 12, further comprising converting the identified text file into an audio file.

14. The method as claimed in claim 9, further comprising providing a list of all recommendations which have been selected for inclusion into a podcast and receiving a vote from a recommender based on a criterion for at least one of the selected recommendations.

15. The method as claimed in claim 9, further comprising receiving a subscription to digital media file from a subscriber.

16. The method as claimed in claim 9, wherein the digital media file is a podcast.

17. A computer program product loadable into the internal memory of a digital computer, for selecting, by comparing one or more media files from a plurality of received recommendations, one or more media files for inclusion into a digital media file, when the program product is run on a computer, the program product comprising software code portions for:
receiving a plurality of recommendations associated with one or more media files from a plurality of recommenders;
determining a weighting factor associated with each of the received recommendations; and
identifying from each of the determined weighting factors each of the recommendations falling within a predetermined threshold and selecting each of these recommendations for inclusion into an audio playlist.
